(19) United States
(12) Patent Application Publication
(10) Pub. No.: US 2016/0132530 A1
(43) Pub. Date: May 12, 2016

(54) IDENTIFICATION OF A DRIVER'S POINT OF INTEREST FOR A SITUATED DIALOG SYSTEM

(71) Applicant: Honda Motor Co., Ltd., Tokyo (JP)

(72) Inventors: TERUHISA MISU, MOUNTAIN VIEW, CA (US); YOUNG-HO KIM, COLLEGE STATION, TX (US)

(21) Appl. No.: 14/536,893

(22) Filed: Nov. 10, 2014

(51) Int. Cl. G06F 17/30; G01C 21/26; G06F 3/01

(52) U.S. Cl. CPC G06F 17/30241; G06F 3/012; G01C 21/26

(57) ABSTRACT

A method for identifying a Point of Interest (POI) of a driver of a vehicle comprises: receiving voice data; receiving head movement data of the driver; determining a location of the vehicle and POIs around the location when the voice data is received; identifying potential POIs of the driver by analyzing the head movement data and a timing of the voice data using Gaussian Process Regression (GPR); and identifying the POI of the driver using a plurality of: a speed of the vehicle, density of surrounding POIs and visual salience.

### TECHNICAL FIELD

The present application generally relates to a situated dialog system, and, more particularly, to a situated dialog system that uses head pose trajectory, velocity of the vehicle, visual salience of objects and/or the number of objects in an area (i.e. density) to identify a user's query of a Point of Interest (POI).

### BACKGROUND

Advances in sensing technologies have enabled designers to develop multi-participant vocal command based systems. Vocal command based systems (VCS) are system that may allow a user to use their voice to control and/or operate the VCS. By removing the need to use physical control devices such as buttons, dials and/or switches, consumers may be able to more easily operate the VCS. This may be particularly useful when the user's hands may be full or when the user's hands may be needed for other purposes.

VCS may be used in vehicles to allow users to more easily control different systems when driving. However, in a moving vehicle, where situated interactions may often take place, the user's stated expressions may not be in a format that the VCS may understand. For example, navigational systems which may use vocal commands may not understand certain driver's expressions. When driving, drivers may use referring expressions about their surroundings such as saying “What is that restaurant?” Since no directional cues such as “on the right” or “right ahead” may be given, the navigational system may have difficulty in determining what restaurant the driver is inquiring about.

Studies have shown that about half of the utterances by drivers may not include specific position and or directional information. Instead, many drivers may use multi-modal cues such as head pose movement or gesture to indicate their target. For example, a driver may use a head pose when looking at a target point of interest (POI). Unfortunately, using head pose information at the start of speech timing may not necessarily contribute to POI identification. The reason for this may be due to: (1) drivers may not continuously look at the target since making a query about the surroundings is generally a secondary task compared to looking forward for their primary task of driving, and (2) the POI may be represented as a point (i.e., longitude and latitude), and the difference between a head direction and the POI direction is not necessarily zero.

Therefore, it would be desirable to provide a system and method that overcome the above identified concerns, as well as additional challenges which will become apparent from the disclosure set forth below.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a method for identifying a Point of Interest (POI) of a driver of a vehicle is disclosed. The method may include: receiving voice data; receiving head movement data of the driver; determining a location of the vehicle and POIs around the location when the voice data is received; identifying potential POIs of the driver by analyzing the head movement data and a timing of the voice data through Gaussian Process Regression (GPR); and identifying the POI of the driver using a plurality of: a speed of the vehicle, density of surrounding POIs and visual salience.

In accordance with another aspect of the present application, a system for identifying a Point of Interest (POI) of a driver is provided. The system has a voice recognition subsystem. The voice recognition subsystem monitors voice data from the driver and processes the voice data into words and phrases. A head recognition subsystem monitors head movement of the driver. A geo-location subsystem identifies a location of the vehicle and POIs around the location when the voice data is monitored. A POI evaluation module is coupled to the voice recognition subsystem, head recognition subsystem, and geo-location subsystem. The POI evaluation module analyzes the head movement data and a timing of the voice data to identify potential POIs of the driver. The POI evaluation module uses a plurality of: a speed of the vehicle, density of surrounding POIs and visual salience to identify the POI of the driver.

In accordance with another aspect of the present application, a method for identifying a Point of Interest (POI) of a driver of a vehicle is disclosed. The method may include: receiving voice data; receiving head movement data of the driver; determining a location of the vehicle and POIs around the location when the voice data is received; identifying words or phrases from the voice data; analyzing the head movement data and a timing of the voice data to identify potential POIs of the driver; and identifying the POI of the driver using a speed of the vehicle, density of surrounding POIs, visual salience and a height of eyes of the driver above a dashboard of the vehicle to identify the POI of the driver, wherein the words or phrases identified during processing of the voice data reduces the density of surrounding POIs and the potential POIs are ranked through visual salience.

### BRIEF DESCRIPTION OF DRAWINGS

Embodiments of the disclosure will become more fully understood from the detailed description and the accompanying drawings, wherein:

FIG. 1A is an exemplary timing diagram illustrating a discrepancy between a driver's head pose direction and speech timing in accordance with one aspect of the present application;

FIG. 1B is an exemplary timing diagram illustrating a discrepancy between a driver's head or other movement and speech timing in accordance with one aspect of the present application;

FIG. 2 is a schematic view of an exemplary system for identifying a driver's Point of Interest (POI) in accordance with one aspect of the present application;

FIG. 3A depicts a relationship between the user head motion trajectory and the POI positions in accordance with one aspect of the present application;

FIG. 3B is an exemplary timing diagram showing the relationship between the user head motion trajectory and the POI positions over time in accordance with one aspect of the present application;

FIG. 4 is an exemplary table depicting a method for determining looking motion intervals in accordance with one aspect of the present application;

FIG. 5A is an exemplary Table show success rate per each driver for BASE-P and GPR with and without timing in accordance with one aspect of the present application;

FIG. 5B is an exemplary chart shown Kernel density estimation results of a plurality of users in accordance with one aspect of the present application;

FIG. 6 is an exemplary chart showing a comparison of success rate (%) in the user-independent condition in accordance with one aspect of the present application;

FIG. 7 is an exemplary chart showing a comparison of success rate (%) in the user-dependent condition in accordance with one aspect of the present application; and

FIG. 8 is an exemplary flowchart depicting a method of determining a driver's POI according to one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

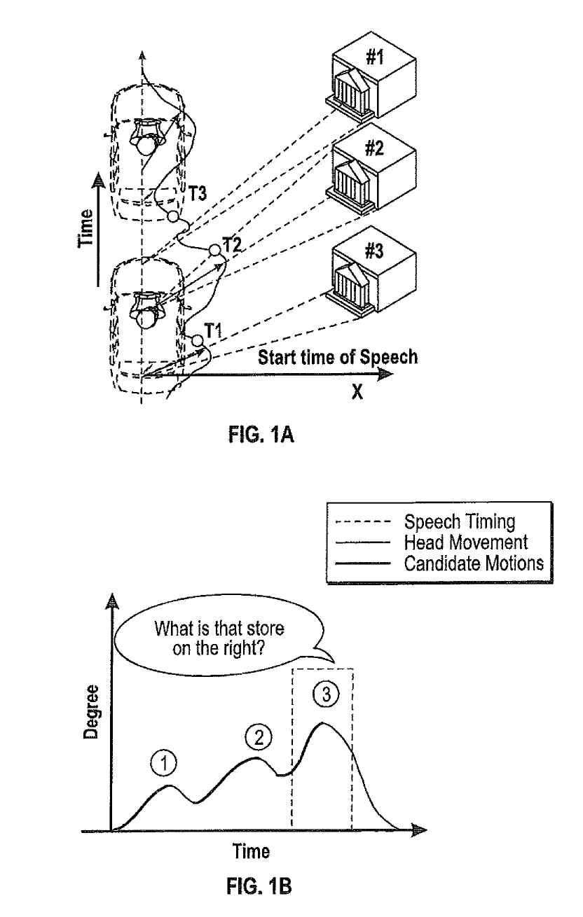

As stated above, head pose information at the start of speech timing may not necessarily contribute to POI identification. To overcome the above, it may be beneficial to track the change sequence (trajectory) of the head pose of the driver. Tracking the trajectory of the head pose of the driver may lead to a more robust inference of POI identification during a short time frame rather than one instant capture. However, using head pose trajectory may not be straightforward due to several reasons, as shown in FIG. 1A. For example, there may be a discrepancy between a driver's head pose direction and speech timing. Thus, a driver may have looked at the POI and started to turn his head back to look at the road before commenting about the POI. The driver's looking motion may not be consistent. Due to different velocities and accelerometer readings of the vehicle, the driver's looking motion may continuously change.

Referring now to FIG. 1B, using head pose trajectory may not be straightforward when driving since there may exists spontaneous varied head pose movement. Due to the varied head pose movement, it may be difficult to link a speech query to a specific pattern. The looking patterns of drivers may be user dependent. Thus, each driver may have different viewing patterns when looking at a POI.

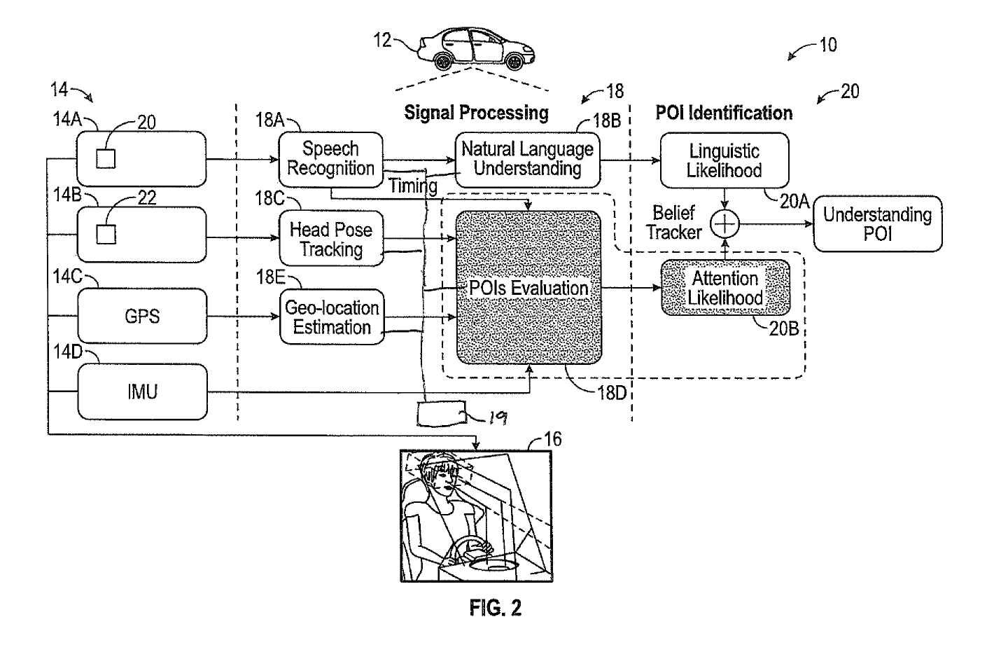

Referring to FIG. 2, an overview of a situated dialog system 10 may be seen. The components of the system 10 may be interconnected via one or more system buses. The system 10 models a driver's looking motion that may be a relationship between the driver's head pose and the target POI direction by using a Gaussian Process Regression (GPR) over time. This may facilities adaptation to a specific user. A kernel density estimation may be incorporated in the time frame to find a head movement that is most closely related to the utterance. The system may use other variables such as the velocity of the vehicle, visual salience of POIs and or the number of objects in an area (i.e. density) in order to help identify the POI.

The system 10 may be implemented in a vehicle 12. The system may have a plurality of monitoring sensors/subsystems 14 (hereinafter monitoring subsystems 14). The monitoring subsystems 14 may be used to monitor inputs from a driver 16 of the vehicle 12 and inputs related to operation of the vehicle 12. In accordance with the embodiment shown in FIG. 2, the system 10 may have a voice recognition subsystem 14A, a head and/or gesture recognition subsystem 14B and a geo-location subsystem 14C, and an inertial measurement unit (IMU) 14D.

The voice recognition subsystem 14A, a head and/or gesture recognition subsystem 14B, and a geo-location subsystem 14C, and an inertial measurement unit (IMU) 14D may be coupled to a processor 18. The processor 18 may be a general processor for the system 10 or an individual processor for each of the above identified subsystems identified above. The processor 18 may have associated memory 19. The processor 18 may be implemented in hardware, software or a combination thereof. The processor 18 may store a computer program or other programming instructions associated with the memory 18 to control the operation of the system 10. The data structures and code within the software in which the present disclosure may be implemented, may typically be stored on a non-transitory computer-readable storage. The storage may be any device or medium that may store code and/or data for use by a computer system. The non-transitory computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed. The processor 18 may be various computing elements, such as integrated circuits, microcontrollers, microprocessors, programmable logic devices, etc, alone or in combination to perform the operations described herein.

The voice recognition subsystem 14A may include one or more microphones 20 located within the vehicle 12. The microphones 20 may be used to monitor verbal data spoken by the driver 16 and/or one or more passengers. The data monitored by the microphones 20 may be sent to a processor 18. The processor 18 may be an individual processor for the voice recognition system 14A or a general processor for the system 10. The processor 18 may have a speech recognition module 18A. The speech recognition module 18A may be configured to receive and determine if verbal data may have been spoken by the driver 16 and/or one or more passengers. The verbal data received by the speech recognition module 18A may be sent to a Natural Language Processing (NLP) module 18B. The NLP module 18A may be used to interpret the verbal data spoken by the driver 16 and/or passengers. The NLP module 18B may generate multiple possible words or phrases based on the verbal input. When the speech recognition module 18A determines that verbal data may have been spoken, the speech recognition module 18A may send a signal indicating the timing of the spoken data to a Point of Interest (POI) Evaluation module 18D the function of which will be disclosed below.

The head and/or gesture recognition subsystem 14B may have one or more cameras 22 located within the vehicle 12. The cameras 22 may be used to monitor movement of the driver 16. The data captured by the camera 22 may be sent to the processor 18. The processor 18 may be an individual processor for the gesture recognition subsystem 14B or a general processor for the system 10. The processor 18 may have a tracking module 18C to monitor and provide an estimation of the position and orientation of a head and/or other body parts of the driver 16. The tracking module 18C may send the position and orientation data calculated to the Point of Interest (POI) Evaluation module 18D.

The system 10 may include a geo-location subsystem 14C. The geo-location subsystem 14C may be a Global Positioning Satellite (GPS) unit. The geo-location subsystem 14C may provide navigation routing capabilities to the driver 16 within the vehicle 12. The geo-location subsystem 14C may include a geo-location device 18E for receiving transmissions from GPS satellites for use in estimating real time location coordinates of the vehicle 12. Based on the GPS location coordinates, the geo-location subsystem 14C may provide surrounding map information such as road network data, destination data, landmark data, points of interest data, street view data, political boundary data, etc which may be viewed on a display. The real time location coordinates and surrounding map infonnation may be sent to the POI Evaluation module 18D.

The system 10 may include an IMU device 14D. The IMU device 14D may be used to measure and record a speed and/or velocity of the vehicle 12. The recorded speed and/or velocity may be sent to the POI Evaluation module 18D. Other devices may be used to measure and record the speed and/or velocity of the vehicle 12. For example, a speedometer may be used to measure and record a speed and/or velocity of the vehicle 12. The speedometer may have a rotation sensor mounted in a transmission of the vehicle 12. The rotation sensor may deliver a series of electronic pulses whose frequency corresponds to the average rotational speed of the driveshaft, and therefore the speed of the vehicle 12. A GPS receiver/transmitter may also be used to measure and record a speed and/or velocity of the vehicle 12.

The signal indicating the timing of the spoken data determined by the speech recognition module 18A, voice recognition subsystem 14A, the position and orientation data calculated by tracking module 18C, the GPS location coordinates and surrounding map data determined by the geo-location device 18E and the speed and/or velocity of the vehicle 12 monitored by the IMU 14D may be sent to the POI Evaluation module 18D. Based on the above information, the POI Evaluation module 18D may be used to narrow down the POI in question.

Data from the NLP module 18B and the POI Evaluation module 18D may be sent to the POI identifier 20. The POI identifier 20 may analyze the above data to determine the POI the driver 16 is looking and/or discussing. The POI identifier 20 may have a linguistic likelihood module 20A. The linguistic likelihood module 20A may provide a “confidence value” for each interpretation of the verbal data determined by the NLP module 18B indicating a likelihood that the verbal data was the actual phrase spoken.

The POI identifier 20 may have an attention likelihood module 20B. The likelihood module 20B may be used to determine the probability that the POI indentified by the POI Evaluation module 18D is accurate. An output of the likelihood module 20B may be combined with an output of the linguistic likelihood module 20A to identify the POI in question.

In the system 10, speech may be the modality that may trigger the POI evaluation by the POI Evaluation module 18D. The POI Evaluation module 18D may list candidate POIs based on the geo-location determined at the speech timing. The likelihood of each candidate POI may be calculated based on the head-pose position and orientation data calculated by tracking module 18C. The POI identification may be done by selecting the POI with maximum POI likelihood, which may be calculated by combining data from the likelihood module 20B with data from the linguistic likelihood module 20A and other factors as disclosed below.

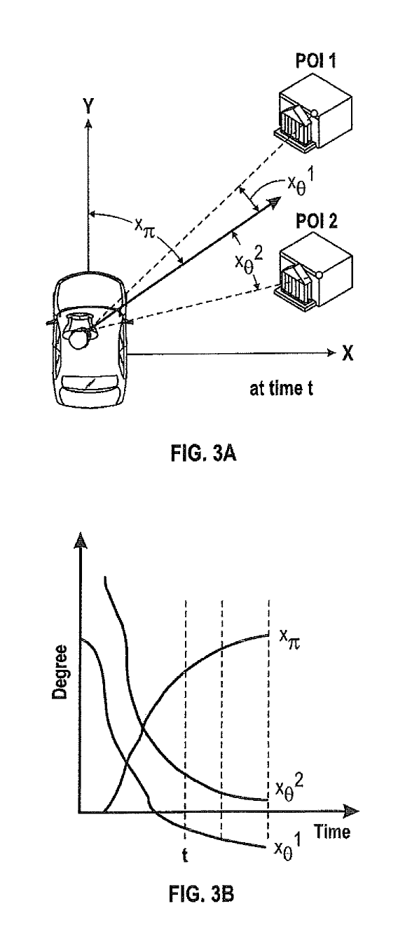

To model a relationship between a head motion trajectory of the driver and a POI position, the system 10 may use multiple measurements. Referring to FIGS. 3A-3B, one measurement may be the angle between the vehicle forward direction and the face direction which may be identified as x_{π}. Another measurement may be the relative angle between the face direction and each POI direction which may be identified as x_{θ}.

When x_{θ} is small, one may presume that the driver is more likely to be interested in the POI. However, timing may be an important factor. For example, in FIG. 3B, the angle x¹_{θ} is smaller than the angle x²_{θ} at time t, but the driver might be on the way to see the POI-2 (FIG. 3A). Thus, one may expect x_{θ} to be small at the end of the looking motion. In addition, x_{θ} might not be zero. Thus, one may consider the whole motion sequence to handle the motion variation as discussed below. Moreover, since the head motion and speech activity do not necessarily occur simultaneously, one may need to select a head motion that relates most closely to the utterance shown in FIG. 1B. Thus, one may need to model the relationship between the head pose sequence and the start of speech timing as discussed below.

As a preliminary way to represent a trajectory, one may define two categorized trajectories as a vector sequence. x_{π}(t) ∈ R may be the head pose degree at time t. Δx_{π}(t) ∈ R may be the head pose velocity at time 1. The moving patterns may be defined as h-th meaningful head trajectory, which is Hₕ=(x_{π}, Δx_{π})h, h E [1, H], where x_{π}=(x_{π}(t₁), . . . , x_{π}(tⱼ)) and Δx_{π}=(Δx_{π}(t₁), Δx_{π}(tⱼ)), H may be the number of a head pose movement sequence, j>0. Let x₀(t) ∈ R be the relative degree of the POI and the face direction at time t. Then, each head trajectory, Hₕ, has r-th candidate POI lists, P^{r}ₕ=(x₀(t₁), . . . , x₀(t₁), where j>j′ and r ∈ [1, R]. R may be the number of a relative POI degree sequence.

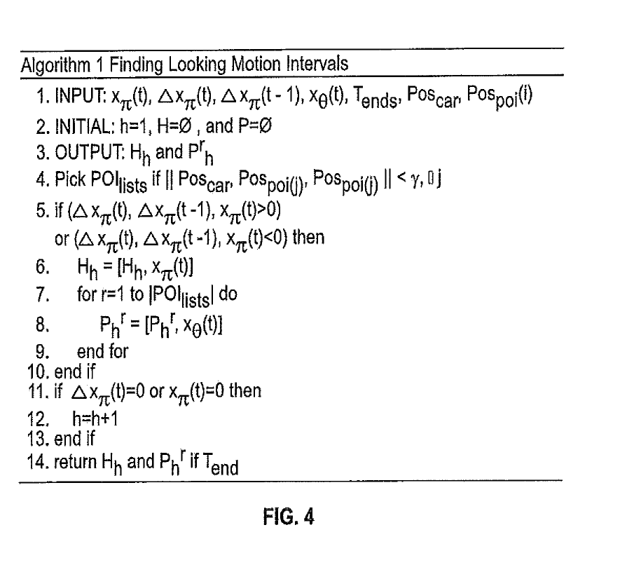

In the system 10, the POI Evaluation module 18D may detect head pose motions that may be related to a driver query. In general, meaningful motion may occur before and during the driver query. The method for detecting motion may be described as shown in FIG. 4.

In FIG. 4, the head and/or gesture recognition subsystem 14B may monitor and determine the inputs in lines 1-2. Based on the meaningful head trajectory, the POI list may be calculated. Line 4 collects candidate POIs from the database based on distance between a car (Pos_{car}) and j-th POI (Posₚₒᵢ₍ⱼ₎). γ may be a threshold parameter. Lines 5 to 10 check whether current head pose is increasing-decreasing with regard to positive-negative head pose, respectively. If the condition is true, then the system 10 collects the pair of point sequences as a meaningful trajectory at the end of speech time, T_{end}, in Line 14.

The collected candidate motion sequence Hₕ and P^{r}ₕ may not be complete trajectories, which means x_{π}(t₁)≠0. In addition, there may different lengths and sampling rates of each trajectory. To overcome these problems, a normalization process may be used. However, since P^{r}ₕ may be related to the variation of Hₕ, P^{r}ₕ may be simply normalized by a reference head trajectory Hₕ. Thus, one can normalize the change scale of P^{r}ₕ by H^{j}ᵣ−H¹ᵣ for all r to scale target P^{r}ₕ to be the same change scale as Hₕ. Moreover, a normalized discretized time frame, L, may be used. The patterns may be normalized by (x_{π}(tⱼ)−x_{π}(t₁))/x_{π}(tⱼ) as a percentage of the trajectory.

One may use Gaussian process regression (GPR) to model POI likelihood (=probability of x₀ given x_{π}). The model may be defined by x₀=f(t)+∈, where ∈˜N(0, σ²) and ,f(t) with mean function m(t)=E[f(t)]=0 and a covariance function k(t,t′)=E[(f(t)−m(t))(f(t′)−m(t′))]. One may chose a kernel function, k(ti, tj), as an exponential kernel. When one has an observation vector (t, x₀)={(tⱼ, x₀(tᵢ)), . . . , (tₙ, x₀(tₙ))}, then a zero-mean multivari ate Gaussian with a n×n kernel matrix, K′ with Gaussian noise, may be K′=K+σ²I. The following posterior density for a test point t*, P(v*_{θ}|t,* x_{θ}), is with the mean μ(t*) and interpolation variance V^{˜}(t*):

μ(t*)=k(t*)^{T}K^{t-1}z,

V¹(t*)=k(t*)^{T}K^{t-1}(x₈−μ(t*))^{T}(x₈−μ(t*)).

where k(t*) is the covariance vector between the queries t* and the observance t. One may consider the interpolation variance V that has informative uncertainty measure, which facilitates the model learning with a few training samples with data variability.

One may defined a model for two classes (motion to look at right and left), χk, k ∈ [1, 2]. Using the model, we may evaluate the probability density of a normalized test pattern, xo to measure similarity as a form of likelihood in the given training class:

$${L}_{h}^{r} ( k ) = \frac{1}{J} {\sum }_{i = 1}^{J} p ( {x}_{θ}^{*} ( i ) \vert {\hat{t} ( i )}^{*} , {x}_{k} ) ,$$

where J may be the number of time frame.

Let T=(T₁, . . . ,T_{H}) be an independent sample drawn from the distribution of timing deviation between the start of speech Tₛₜₐᵣₜ and the end time of h-th head pose sequence t^{h}ⱼ where Tₕ=t^{h}ⱼ−Tstart, h ∈ [1, H]. Then one may employ kernel density estimation (KDE) for an unknown density f. The shape of the function

$${\hat{f}}_{B} ( x ) = \frac{1}{hB} {\sum }_{i = 1}^{h} K ( \frac{x - {T}_{i}}{B} )$$

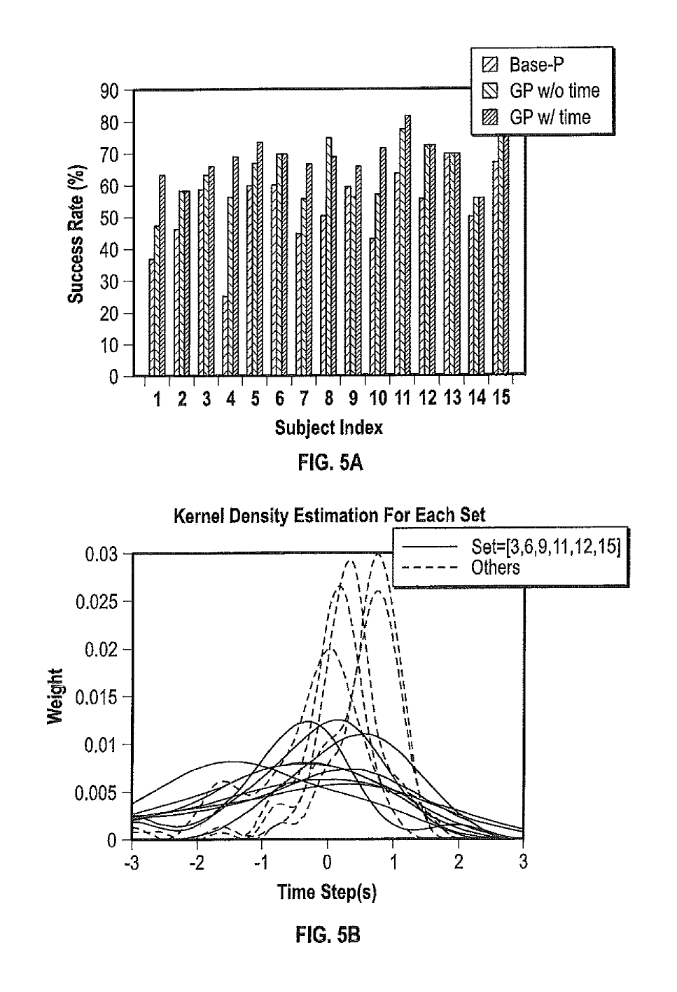

may be estimated where B may be a bandwidth. One may choose a kernel function, K, as a Epanechnikov kernel. The timing model may be demonstrated as shown in FIG. 5. Once we have \hat{f}_{B}(x) one may get the weight of each head trajectory. That is ωₕ=δ·\hat{f}_{B}(tₕ) for h ∈ [1, H], where δ is a normalization factor. Then, the head motion likelihood toward POIs may be defined by the weighted sum Σₕ₌₁^{H}ωₕ·Lₕ^{T}(k).

Two different baseline methods may be used. One may be by capturing the instant value of x_{θ} at the start of speech timing. The second may be a Gaussian mixture model (GMM)-based method that uses a start of speech time to capture the POIs distance from the vehicle position. Additionally, one may employ two baselines that use xo or GMM at a peak-heading (end-of-the-motion) timing tⱼ disclosed above. To investigate the effects of 1) using trajectory and 2) timing information, one may evaluate two variations of the proposed method. One picks the end timing tⱼ of the head pose sequence that has the closest timing between the end time tⱼ and Tₛₜₐᵣₜ. Another may uses the timing model based on head pose sequence. In summary, the following methods may be compared:
1. Use x_{θ} at the Start-of-speech timing/Peak-of-heading timing, (BASE-S/BASE-P); the likelihood calculation is that the smaller x_{θ} of POIs may be the higher score.
2. Use distance to the POI at the Start-of-speech timing/Peak-of-heading timing, (GMM-S/GMM-P); the likelihood calculation may be based on the trained distance modeled by GMM.
3. Use GPR (with or without timing weight) for the likelihood calculation

One may judge if the system 10 successfully understands a user query when the likelihood of the target (user-intended) POI is the highest. The chance rate, given by the average of the inverse number of candidate POIs in the POI look-up, may be approximately 10.0%.

Two training conditions may be used as testing of the above: user-independent and user-dependent. In the user-independent condition, models (GPR, GMM parameters, KDE function for timing) may be trained based on user-based cross-validation, where data from different subjects may be used to train the model and the data from the remaining subject may be used to test it. The user-dependent condition may use session-based cross-validation. The remaining session may be used for evaluation. All training data may be complemented by stable data, which may consist of numerous other complete trajectories by another subject.

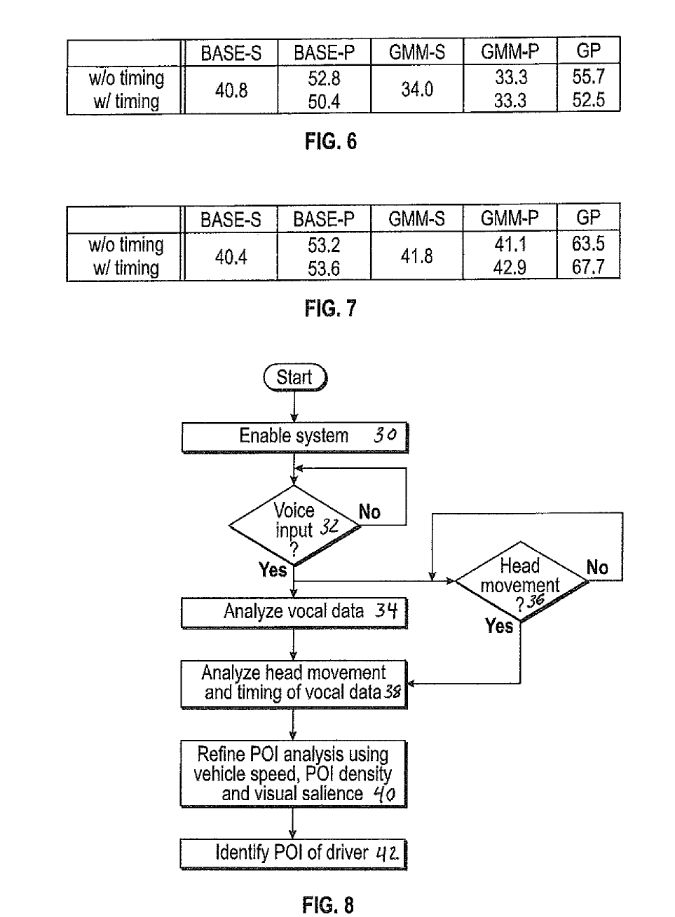

One may first analyzed the effect of using head pose trajectory by comparing BASE-S, BASE-P, and GPR. As may be seen in FIG. 6, a table may be seen showing the success rates of the above-mentioned methods. Using peak-of-heading timing shows approximately 12% improvement over the method which uses start-of-speech timing in the user-independent condition. Considering trajectory patterns in GP is improved by 3%. These results support that a head trajectory pattern is still useful to improve the system even in the user-dependent case.

Next, one may evaluate the timing effects in FIG. 6 and FIG. 7. Using timing information degraded the performance from 55.7% to 52.5% in the user-independent condition. We see a similar result in BASE-P. This may indicates that the timing model might be user-dependent.

One may evaluate the methods in the user-dependent training condition. Referring to FIG. 6, a table of the results may be seen. In this condition, combining timing information with the GPR method leads to improvement. One may achieve a success rate of 67.7%, outperforming the method that does not use timing information (63.5%). Considering that this performance (67.7%) is achieved with a fewer number of training data compared to the user-independent condition, this indicates that speech timing has user-dependent patterns. While a 67.7% in success rate may not be satisfactory, the success rate may go up to 81.2% if one considers 2nd rank in the user-dependent case. The performance may still be higher when one combines the attention likelihood with linguistic likelihood.

As stated above, performance of system 10 may be improved by using speech timing. Referring to FIGS. 5A and 5B, one may see the success rate per each driver for: BASE-P and GPR w/ or w/o timing (FIG. 5A) and kernel density estimation results per user (FIG. 5B). The kernel density estimation shows two groups: consistent timing and non-consistent timing. As one may see, the GPR-based method with timing is generally more effective for users with non-consistent timing. The performances of subject numbers 1, 4, 7, and 10 increased significantly using the speech timing.

Determining the POI in question may be more time sensitive due to the rapidly changing environment while driving. Thus, the speed of the vehicle 12 may be used as a factor to help identify the POI in question. In the system 10, the POI Evaluation module 18D may use the speed of the vehicle 12 to refine and identify the POI in question. Based on the speed of the vehicle 12, the POI Evaluation module 18D may place more emphasis on certain parameters than other when determining the POI in question.

For example, if the vehicle 12 is stationary, such as when the vehicle 12 may be stopped at a traffic light, the POI Evaluation module 18D may place more weight on the amount of time the driver 16 is looking at an object (i.e., POI). The longer the length of time the driver 16 is looking at the object, the more likely, the object is the POI in question. However, if the vehicle 12 is moving along a road, then less weight may be given to amount of time the driver 16 is looking at an object (POI) since looking at the POI is generally a secondary task compared to their primary task of looking forward and driving.

The system 10 may have one or more predefined speed levels. At each predefined speed levels, different criteria and/or different emphasis maybe placed on the factors monitored. For example, if the vehicle 12 is traveling at 0-10 mph, more emphasis may be placed the amount of time the driver 16 is looking at an object (i.e., POI). As the speed of the vehicle 12 increases past 10 mph, less emphasis maybe given to the amount of time the driver 16 is looking at an object (i.e., POI). If the vehicle at 10-20 mph, the system 10 may place more emphasis on an initial time vocal data is spoken by the driver 16, directional comments in the vocal data which may be ascertained by the NLP module 18B, and/or visual salience of the POIs as disclosed below. Thus, the faster the speed of the vehicle 12, the less emphasis may be given to the amount of time the driver 16 is looking at an object (i.e., POI).

POI density may be used to help identify the POI in question. POI density may be defined as the number of objects (POI) per a defined boundary area. If the POI density is low, it may be easier to identify the POI in question since there are fewer objects in question. The main deference between a residential area and a downtown area may be the POI density. For example, in a downtown setting, the number of POIs per 50 meter radius may be on average 7.2 POIs. However, in a residential setting, the number of POIs per 50 meter radius may be on average 1.9 POIs. Thus, due to the higher number of potential POIs in a downtown setting, it may be more difficult to identify the POI in question. Thus, in an area were the POI density is high, the POI Evaluation module 18D may try and lower the number of POls in question and hence lower the POI density in order to refine a response.

For example, in a downtown setting, directional and/or other comments in the vocal data which may be ascertained by the NLP module 18B may be used to lessen the number of POIs in question, thereby lower the POI density. If a driver were to utter “What restaurant is that?” the NLP module 18B may eliminate all non-restaurant buildings in the area, thereby lowering the POI density. Similarly, if the driver were to utter “What is the brown building?” the NLP module 18B may eliminate all buildings in the area that are not brown, thereby lowering the POI density.

Similarly, head pose data may be used to lessen the number of POIs in question. If the driver 16 was looking to the left, the POI Evaluation module 18D may determine that all POls located in front of or to the right of the vehicle 12 may be eliminated thereby lowering the POI density.

It should be noted that a combination of directional and/or other comments in the vocal data which may be ascertained by the NLP module 18B and head pose data may be used to lower the POI density. For example, if a driver were to utter “What restaurant is that?” the NLP module 18B may eliminate all non-restaurant buildings in the area, thereby lowering the POI density. If the driver 16 was looking to the left when the driver made the above statement, the POI Evaluation module 18D may determine that all restaurants located in front of or to the right of the vehicle 12 may be eliminated thereby lowering the POI density. The above are given as examples as to how the POI Evaluation module 18D may lower the POI density in order to refine and identify the POI in question and should not be seen in a limiting manner.

Visual salience may be used to determine the POI in question. Visual salience may be defined as a distinct subjective perceptual quality which makes some items in the world stand out from their neighbors and immediately grab our attention. The basic principle behind determining visual salience is the detection of POIs whose visual attributes differ from the surrounding POIs attributes, along some dimension or combination of dimensions. Thus, POIs having a higher visual salience may be listed higher on the list as the potential POI in question. For example, certain well known landmarks may have a higher visual salience than other POIs in the area since these landmarks may be well known in appearance. Thus, if a driver is in an area where there is a well know landmark such as the Capitol Record Building in Los Angles, the POI Evaluation module 18D may place the Capitol Record Building higher on the list as a potential POI of interest.

Other factors that may affect visual salience may be visual appearance of a POI and/or size of the POI. For example, buildings with a bright/colorful paint color may be more likely to draw the attention of a driver than building with a more traditional or earth tone paint color. Similarly, a building with signage may be more likely to draw the attention of a driver than a building without signage. If the signage is flashing, the building will have a higher visual salience than a building with no flashing signage. Thus, between two similar buildings, a driver's attention may more likely be drawn to the building having a brighter paint color, or flashing signage as opposed to a building with a normal paint color and no signage.

Thus, the POI Evaluation module 18D may place POIs having a higher visual salience higher on the list as a potential POI of interest.

A driver's height and/or a height of the vehicle 12 may be used to help identify the POI in question. A height of the driver or how low the vehicle 12 sits to the ground may affect a field of view (FOV) of the driver. Thus, different drivers may have different POIs in their FOV based on the driver's height and/or how low the vehicle 12 sits to the ground. Shorter drivers or drivers in vehicles 12 that may sit low to the ground may have a FOV that may be slightly obstructed when compared to drivers who may be taller or are in vehicles 12 that may sit higher off the ground. Thus, shorter drivers or drivers in vehicles 12 that may sit low to the ground may have fewer POIs in their FOV than taller drivers or drivers in vehicles 12 that may sit higher off the ground. For example, when driving in a downtown setting, drivers in a vehicle 12 that may sit low to the ground, may have their FOV obstructed by other vehicles that sit higher off the ground, certain signage on the street or on buildings, or other objects in the area. Thus, these drivers may have fewer potential POIs in their FOV. However, taller drivers or drivers in vehicles 12 that may sit higher off the ground, may have unobstructed FOVs and more potential POIs in their FOV.

Most vehicles 12 have seats that are adjustable. The adjustable seats may allow the driver to raise or lower the height of the seat. While it is disclosed above, that river's height may be used to help identify the POI in question, this may include a position of the driver's eyes above the dashboard of the vehicle 12. For example, a taller driver may adjust the seat in the vehicle 12 to sit lower to the ground, while a shorter driver may raise the seat to sit higher above the dashboard. In the above case, the shorter driver may have a clearer and less obstructed FOV since the shorter driver is sitting higher above the dashboard when compared to the taller driver. Thus, the higher the eyes of the driver are above the dashboard of the vehicle 12, the better the potential of having a clearer and less obstructed FOV.

FIG. 8 illustrates operation of the system 10 (FIG. 2) for determining a driver's POI based on head pose trajectory, velocity of the vehicle, size and visual salience of objects and/or the number of objects in an area verbal and gestural cues. The operation of the system 10 may begin once the system 10 is enabled as shown in Box 30. In one embodiment, the system 10 may be selectively enabled by the driver 12 of the vehicle 10 using an input button or toggle switch. In an alternate embodiment, the system 10 may be enabled by default once the vehicle 10 receives power (i.e., when the vehicle is put into an accessory or vehicle engine is enabled).

Once the system 10 is enabled, the system 10 may determine if vocal data has been received as shown in Box 32. If vocal data has been has been received, the vocal data may be analyzed as shown in Box 34. The vocal data may be analyzed to determine if the vocal data contains any recognizable words and/or phrases to help identify the POI. The system 10 may also monitor a position of the driver's head as shown in Box 36.

If the position of the driver's head has moved more than a predetermined amount, data related to timing of the verbal data spoken, position of the driver's head, GPS data and vehicle data may be analyzed as shown in Box 38. When analyzing head movement of the driver 12 and timing of the spoken data, multiple methods may be employed. As disclosed above, methods such as capturing the instant value of x_{θ} (i.e., the relative degree between the face direction and each POI direction) at the start of speech timing or a Gaussian mixture model (GMM)-based method that uses a start of speech time to capture the POIs distance from the car position. Additionally, two baselines may be employed that use x_{θ} or GMM at a peak-heading (end-of-the-motion) timing tⱼ. The method used by the system 10 may be based on tendencies of the driver using the system 10.

A Gaussian Process Regression (GPR) based method with timing is more effective for users with non-consistent timing. As shown above, the GPR based method with timing has a higher success rate in identifying the POI in question as compared to a method of capturing the instant value of x_{θ} (i.e., the relative degree between the face direction and each POI direction) at the start of speech timing or a GMM.

In the GPR-based method, the system 10 models a driver's looking motion that is a relationship between the driver's head pose and the target POI direction by using the Gaussian Process Regression GPR over time. This may facilitate adaptation to a specific user. Then, the system 10 may incorporate a kernel density estimation in the time frame to find a head movement that is most closely related to the verbal data utterance.

Other data related to POI density, speed of the vehicle and visual salience may be used to narrow down the POI in question as shown in Box 40. As disclosed above, in the system 10, the POI Evaluation module 18D may use the speed of the vehicle 12 to refine and identify the POI in question. Based on the speed of the vehicle 12, the POI Evaluation module 18D may place more emphasis on certain parameters than other when determining the POI in question. For example, if the vehicle 12 is stationary and/or moving slowly, the POI Evaluation module 18D may place more weight on the amount of time the driver 16 is looking at an object (i.e., POI). If the vehicle 12 is driving along a road, more emphasis may be given to an initial time vocal data is spoken by the driver 16, directional or other comments in the vocal data which may be ascertained by the NLP module 18B, and/or visual salience.

POI density may be used to help identify the PO1 in question. The system 10 may try to lessen the POI density in order to aid in the identification of the POI in question. As stated above, directional and or other comments in the vocal data which may be ascertained by the NLP module 18B and head position may be used to lessen the number of POIs in question, thereby lower the POI density.

Visual salience may be used to determine the POI in question. Thus, POIs whose visual attributes differ from the surrounding POIs attributes, along some dimension or combination of dimensions may be given higher ranking on the list as potential POIs of interest

A driver's height and/or a height of the vehicle 12 may be used to help identify the POI in question. A height of the driver or how low the vehicle 12 sits to the ground may affect a field of view (FOV) of the driver. Thus, different drivers may have different POIs in their FOV based on the driver's height and/or how low the vehicle 12 sits to the ground.

Based on the POI density, speed of the vehicle, visual salience and height of the driver, the POI of the driver may be determined as shown in Box 42.

While embodiments of the disclosure have been described in terms of various specific embodiments, those skilled in the art will recognize that the embodiments of the disclosure may be practiced with modifications within the spirit and scope of the claims.

What is claimed is:

1. A method for identifying a point of interest (POI) for a driver comprising:
receiving voice data;
receiving head movement data of the driver;
determining a location of the vehicle and POIs around the location when the voice data is received;
identifying potential POIs of the driver by analyzing the head movement data and a timing of the voice data through Gaussian Process Regression (GPR); and
identifying the POI of the driver using a plurality of: a speed of the vehicle, density of surrounding POIs and visual salience.

2. The method of claim 1, wherein receiving head movement data of the driver comprises analyzing a time frame when the voice data was monitored by kernel density estimation.

3. The method of claim 1, comprising identifying words or phrases from the voice data.

4. The method of claim 3, comprising reducing density of surrounding POIs through the words or phrases identified during processing of the voice data.

5. The method of claim 1, comprising ranking the potential POIs through visual salience.

6. The method of claim 1, wherein identifying the POI of the driver comprises using a height of a driver's eyes above a dashboard of the vehicle.

7. The method of claim 1, wherein identifying the POI of the driver comprises using a height of the vehicle above a road.

8. A system for identifying a Point of Interest (POI) of a driver comprising:
a voice recognition subsystem monitors voice data from the driver and processes the voice data into words and phrases;
a head recognition subsystem monitors head movement of the driver;
a geo-location subsystem identifies a location of the vehicle and POIs around the location when the voice data is monitored;
a POI evaluation module coupled to the voice recognition subsystem, head recognition subsystem, and geo-location subsystem analyzing the head movement data and a timing of the voice data to identify potential POIs of the driver, the POI evaluation module using a plurality of: a speed of the vehicle, density of surrounding POIs and visual salience to identify the POI of the driver.

9. The system of claim 8, wherein the voice recognition subsystem comprises:
at least one microphone;
a speech recognition module receives and determines if verbal data is spoken by the driver;
a Natural Language Processing module interprets the verbal data and generates potential words or phrases of the verbal input.

10. The system of claim 9, wherein the voice recognition subsystem comprises a linguistic likelihood module provides a “confidence value” for each interpretation of the verbal data determined by the NLP module.

11. The system of claim 8, wherein the head movement recognition subsystem comprises:
at least one camera; and
a tracking module monitors and provides an estimation of a position and orientation of a head the driver.

12. The system of claim 8, wherein the POI evaluation module analyzes the head movement data and a timing of the voice data through Gaussian Process Regression (GPR) to identify potential POIs of the driver.

13. The system of claim 8, wherein the POI evaluation module uses kernel density estimation during a time frame when the voice data was monitored.

14. The system of claim 8, wherein the POI evaluation module reduces a density of the surrounding POIs using the words or phrases identified during processing of the voice data.

15. The system of claim 8, wherein the POI evaluation module uses visual salience to rank the potential POIs of the driver.

16. The system of claim 8, wherein the POI evaluation module uses a height of a driver's eyes above a dashboard of the vehicle to identify the POI of the driver.

17. The system of claim 8, wherein the POI evaluation module uses a height of the vehicle above a road to identify the POI of the driver.

18. A method for identifying a Point of Interest (POI) of a driver of a vehicle comprising:
receiving voice data;
receiving head movement data of the driver;
determining a location of the vehicle and POIs around the location when the voice data is received;
identifying words or phrases from the voice data;
analyzing the head movement data and a timing of the voice data to identify potential POIs of the driver; and
identifying the POI of the driver using a speed of the vehicle, density of surrounding POIs, visual salience and a height of eyes of the driver above a dashboard of the vehicle to identify the POI of the driver, wherein the words or phrases identified during processing of the voice data reduces the density of surrounding POIs and the potential POIs are ranked through visual salience.

19. The method of claim 18, wherein Gaussian Process Regression (GPR) analyzes the head movement data and a timing of the voice data.

20. The method of claim 15, wherein kernel density estimation analyses a time frame when the voice data was monitored.
